(19) United States
(12) Patent Application Publication
(10) Pub. No.: US 2016/0302435 A1
(43) Pub. Date: Oct. 20, 2016

(54) VERFAHREN UND VORRICHTUNG ZUM EINBRINGEN VON SALZ IN LEBENSMITTEL

(71) Applicant: DEUTSCHES INSTITUT FÜR LEBENSMITTELTECHNIK E.V., Quakenbrück (DE)

(72) Inventor: Bernhard Hukelmann, Quakenbrueck (DE)

(73) Assignee: Deutsches Institut Fur Lebensmitteltechnik E.V., Quakenbruck (DE)

(21) Appl. No.: 15/029,841

(22) PCT Filed: Oct. 20, 2014
(86) PCT No.: PCT/EP2014/072469

§ 371 Date: Jun. 23, 2016

(30) Foreign Application Priority Data
Oct. 18, 2013 (DE) 10 2013 221 237.2

(51) Int. Cl. A23B 4/02; A23B 4/32

(52) U.S. Cl. CPC A23B 4/02; A23B 4/325; A23L 13/72; A23V 2002/00

(57) ABSTRACT

The invention relates to a method and a device designed for the method for introducing food additives, in particular salt, into solid food, in particular raw or cooked meat. The device according to the invention and the method which can be carried out using said device are characterized in that the solid is introduced into solid food by means of a conveying device for accelerating the solid.

The present invention relates to a process and to a device adapted to the process for introducing food additives, which can optionally be water soluble and which can especially comprise salt, seasoning and preservation agents, into solid food, especially into raw or cooked meat. The device according to the invention and the process which can be carried out using the device are characterized in that at least one solid is introduced into solid food, which optionally comprises or consists of at least one solid that is partially, preferably entirely water soluble food additives. The solid can consist of one or several food additives, especially of solid salt, preferably in admixture with further food additives, for examples spice, preservation agent. The device and the process have the advantage that thereby the food additives, especially salt, can be introduced into the food without introducing solution water.

EP 0537855 A2 describes the injection of brine into meat by a multitude of parallel needles which in coupling with the advance of a conveyor device are pressed into the meat. The injection of the brine into meat is disadvantageous in that along with the brine solution water is introduced, which can impair product quality and can only be removed by costly drying procedures.

WO 00/32051 A1 describes spraying of small solid particles respectively powder by means of high pressure nozzles onto poultry meat. Preferably, sprayed particles are brought onto the meat by electrostatic separation.

### OBJECT OF THE INVENTION

It is an object of the invention to provide a device and a process that can be performed with it for introducing food additives, especially salt, into solid food, by which the introduction of solution water is avoided.

### GENERAL DESCRIPTION OF THE INVENTION

The invention achieves the object by the features of the claims, especially by a device having a conveyor device which is adapted for acceleration of a solid, comprising or consisting of food additives, and having an outlet that can be directed onto the food, especially directed onto an area adjacent to a carrier, in which the food is arranged. The carrier can for example be a conveyor belt or a chute, onto which adjacent the food can be arranged, or another carrier, which engages with the food, like e.g. a hook especially when the food is meat, so that the food is arranged in the area adjacent below the hook.

The solid comprises or consists of preferably salt, e.g. pure table salt (NaCl, optionally having a content of MgCl₂ and/or KCl) or a mixture of table salt with food additives, for example spices, flavour, preservation agents, e.g. nitrite, coloring agents, binding agents, e.g. glucose, glucose syrup, phosphates, sugar etc. According to the invention, the solid is for example a mixture of salt with other food additives and under ambient conditions is solid, especially free from solution water.

Generally, it is preferred that the conveyor device is supported moveable in relation to the carrier by a mounting in order to arrange the outlet at a small distance from the food. The mounting can e.g. have an optical control or a distance piece to be arranged against the food, which adjusts a predetermined distance of the outlet to a food.

In a first embodiment, the conveyor device is especially arranged to accelerate the solid up to at least a speed sufficient for penetration into the food, e.g. up to a penetration depth of 0.5 to 5 cm. Such a speed necessary for penetration is dependent on ballistic factors, e.g. on the grain size or the diameter and the mass of the solid piece, the distance of the outlet to the food, the resistance of the air etc. This speed can e.g. be predetermined by accelerating the solid of a certain grain size onto an optically transparent substitute material for the food and determining the penetration depth. For example, aqueous compositions solidified with gelatine or soap, e.g. having a Bloom number of 200-350, as they are available e.g. as ballistic gelatine or soap are suitable as such an optically transparent substitute material for food.

The conveyor device in a first embodiment can be a nozzle loadable with compressed gas having e.g. from 50-5000 bar, e.g. 150 to 500 bar, the inner volume of the nozzle being connected with the outlet of a proportioning apparatus for the solid. Preferably, the nozzle is loadable with compressed gas in a controlled manner, for example by the nozzle being connected with a source for compressed gas, for example a compressor or a compressed gas cylinder, by means of a pressure pipe, in which a controlled valve is arranged. Preferably, the valve is controlled in dependence on the position of the carrier, for example in dependence on the position of a motor drive of the carrier or in dependence on the signal of a position detector detecting the position of the food on the carrier, wherein the signal indicates the position of the food. Such a detector can be a camera. At the conveyor device, a proportioning apparatus is arranged which is connected to the inner volume of the conveyor device and which is especially adapted to conduct the solid to the inlet end of the conveyor device, the outlet end of which being oriented to an area adjacent the carrier. Further preferred, also the proportioning apparatus is controlled, for example in dependence on the position of the carrier or in dependence on the detected position of the food on the carrier, e.g. as described with reference to the controlled valve. The proportioning apparatus can be controlled in a manner coordinated with the valve that is arranged in the pressure pipe, for example in a way that the proportioning apparatus prior to and/or during the open position of the control valve conveys solid into the nozzle. The nozzle can be loadable with compressed gas in a continuous manner or periodically controlled pulsatingly e.g. by the valve in the pressure line being opened and closed periodically. The grain size of the solid is preferably preadjusted to a predetermined size in order to achieve defined penetration depths for the pressure of the pressured gas.

In a first embodiment the device is adjusted to position the outlet of the nozzle in a predetermined distance relative to the food in order for compressed gas to escape that exits from the nozzle. For the predetermined distance, the nozzle can have a distance piece projecting over its outlet, wherein the end of the distance piece spaced from the outlet can be arranged against a food. Such a distance piece can e.g. be a roller or a sliding element.

In the first embodiment the proportioning apparatus can be a feeding line provided with a controlled valve, the feeding line discharging into the nozzle, which optionally conveys the solid by way of gravity or which has a transporting element, for example a motor driven transport screw or a driven slidable piston within the feeding line. The pressured gas can be nitrogen, CO₂ and/or air or also an ignitable mixture of gases, wherein the nozzle has an ignition apparatus for igniting the ignitable gas mixture for acceleration of the solid. For the purposes of the invention, every piston can be a driven slidable element which is guided along a line and a pipe section, respectively.

As described with reference to the second embodiment, the proportioning apparatus can be heatable to a temperature at which at least a part of the food additives becomes flowable or melts, respectively. In this variant, the food additives by at least partially fusing on or melting on at least after solidification on an adjacent cooling line or within the nozzle form a particular solid, which especially is a rod-shaped solid.

In a second embodiment the conveyor device comprises a press with a line connected thereto, the outlet of which being preferably directed to the area adjacent to the carrier, and in which the food is arranged, respectively, such that the outlet can be arranged close to or in contact with the food.

The press can e.g. be an extruder, a piston press or a gear pump. The press has an inlet for the food additives, especially salt or a salt mixture with other food additives, which are to be introduced into the meat and which is adjusted to load the food additives with a pressure under which these are formed to a rod-shaped solid. Therein, the solid is at least sectionwise in one piece, especially rod-shaped. Preferably, the press is air-conditioned, e.g. temperature controlled, e.g. sectionwise heated or cooled, e.g. by a double wall of the housing, in the case of an extruder optionally additionally of the rotor. The line, which is connected to the press, at least sectionwise forms the solid exiting from the press to rods, while the food additives are pushed through the line by means of the press. The conveyor device having a line and a press can be designed to achieve in the line a pressure sufficient for plastically deforming the food additives in the line, for example by the tapering towards its outlet at constant conveyor speed of the press, and thereby increasing the pressure in the food additives towards the outlet, e.g. to recrystallize and/or adhere food additives to one another. Correspondingly, the line can taper from its section adjacent the press to its outlet or can have a constant inner cross-section. The line adjacent to the press can be formed by a nozzle which tapers the open inner cross-section of the press to an outlet.

Optionally, especially in the embodiment as an extruder, the press and/or the line arranged adjacently can have at least one steam exit from the inner volume, for example steam exit borings for water to exit from the pressed food additives. In this embodiment solution water can be added to the food additives fed to the press, e.g. for producing a pumpable mixture, in which optionally food additives can be present as a solid, e.g. crystallin. The mixture of food additives with solution water can e.g. form a slurry, in which the water soluble food additives can partially be present non-dissolved or crystallin.

Optionally, the line is heatable in a section adjacent to the press, which section can e.g. be provided with a double wall for a thermostating medium. The cross-section and the outlet of the line preferably are round.

The outlet of the line can e.g. have an inner diameter of 0.2 or 0.5 mm to 25 mm or up to 15 mm, e.g. 2 to 10 mm, preferably 2 to 7 mm or up to 6 mm, e.g. up to 3 mm or up to 2 mm.

In the second embodiment the food additives are formed to a rod-shaped solid, especially to salt mass, having a strength sufficient to be introduced into the food by means of the press and the line connected thereto. Therein, only the pressure impinged upon the food additives by the press can accelerate the rod-shaped solid into the food, so that in the process the solid following exiting from the outlet of the line is introduced into the food. Therein, it is generally preferred that in the second embodiment during the introduction of the rod-shaped solid, the food is not moved in relation to the outlet. The carrier of the device can especially have forms which are open towards the outlet, and respectively the food can be arranged in forms which are open towards the outlet, the forms reducing a movement of the food during the introduction of the solid.

The press and/or the line connected thereto can be heatable up to a temperature at which at least a portion of the food additives becomes flowable or melts under the pressure generated by the press.

The press and/or the line connected thereto can be coolable up to a temperature at which the mixture of the food additives coheres by its residual moisture, especially water contained therein freezes, e.g. coheres for a short term as required for introduction into the food. During forming of the solid, especially of the rod-shaped solid, by cooling, especially by cooling the press and/or the line connected thereto, frozen water forms a binding agent of the food additives.

Optionally, the conveyor device can have a transportation device connected to the outlet of the line, the transportation device accelerating the rod-shaped solid following it exiting from the outlet of the line against the food. Such a transportation device can e.g. have a pipe section at the inlet end of which, directly or at a distance, a pressure gas source is connected and the outlet end of which is directed to the food. At its inlet end, the pipe section can be sealable, e.g. by means of a closure, e.g. a flap or a gate valve. Preferably, the closure is movably guided approximately in parallel to the cross-section of the pipe section, e.g. in a guidance arranged in parallel to the cross-section of the pipe section. The inlet end can e.g. be arranged adjacent to or in a distance from the outlet of the line, so that rod-shaped solid inserted into the inlet end and compressed gas can be applied to the pipe section, especially following closing of the inlet end. Application of compressed gas generally preferably occurs pulsatingly for accelerating the rod-shaped solid out of the pipe section.

Optionally, the transportation device can have a mechanical ejection device, which is e.g. driven electronically, pneumatically or chemically (by controlled explosion), which correspondingly accelerates the solid. The drive of the mechanical transportation device can e.g. in a pressure chamber store pressure which is admitted to the transportation device and is controlled by opening a closure locked in place of the pipe section at a suitable point in time. In the alternative, the transportation device can have a piston guided in a pipe section in order to accelerate or press, respectively, the solid into the food.

In the line connecting a pressure gas source with the pipe section, there is preferably arranged a controlled valve which preferably is controlled in dependence on the closing of the pipe section. The valve preferably is a fast switchable valve.

In a variant of the second embodiment, the device has a supply container for rod-shaped solid, which is pre-produced. The outlet of the supply container is arranged at a transportation device as described with reference to the second embodiment. In this variant, the supply container forms an intermediate storage for pre-produced rod-shaped solid, so that the transportation device can be separated by a space and/or with a time shift and can be operated for introduction of the rod-shaped solid into the food.

In an alternative to the press or as a feeding device connected to the press for food additives of the second embodiment, for at least a portion of the food additives the device can have a heating device that is heatable to a temperature at which at least a portion of the food additives becomes flowable and melts, respectively. Such a heating device can e.g. be arranged for through-passage of heat-resistant food additives, e.g. salt, and discharge into the press at a distance from a feeding socket of the press for temperature-sensitive food additives. The heating device can be arranged for only partially softening or melting heat-resistant food additives or for providing a melt of these food additives. The heating device can also be actuated in combination with a pressure increase in order to soften the food additives.

The process for producing food with the step of introducing the rod-shaped solid of food additives into food comprises to accelerate the solid by means of a conveyor device, the outlet of which is oriented towards the food.

In the first embodiment, the solid is accelerated at least to a speed sufficient for penetration into the food. The solid can e.g. be accelerated by means of the application of compressed gas in a nozzle, especially controlled by means of a controlled valve, which is arranged in the pressure line between the pressure gas source and the nozzle.

In the second embodiment, the food additives are formed to a rod-shaped solid, especially pressed to a rod-shaped solid, by means of the press, to which a line is connected. The rod-shaped solid can be shoven into the food directly following exiting the line, optionally driven by the pressure of the press or alternatively by means of a pipe section adjacently arranged to the line, the pipe section following entry of the rod-shaped solid of food additives being applied with compressed gas or is accelerated by means of a piston guided in the pipe section. Such a pipe section to which compressed gas can be applied in a controlled manner can preferably be closed at its inlet end facing the outlet of the line, especially closable in coordination with the application of compressed gas. In an alternative, the rod-shaped solid of food additives can be shoven into the food by a driven piston. The piston can be guided in a pipe section arranged at the outlet of the line, the pipe section being oriented towards the food.

In a variation of the second embodiment, the food additives the solid consists of, can be carried into the press with an addition of solution water and/or of a solvent, wherein the press and/or the line connected thereto has at least one steam outlet for the solution water and solvent, respectively to exit from the food additives and out of the rod-shaped solid subjected to pressure, respectively.

In this embodiment, the rod-shaped solid also has no solution water and has a mechanical strength sufficient to penetrate into the food.

The process provides for the introduction of solids of food additives, especially of salt, including salt mixtures, into the volume of a food without introducing solution water. Accordingly, foods produced by the process are characterized in that the structure is not changed by the introduction of solution water, optionally with subsequent discharge of solution water, as well as by a more uniform distribution of food additives from the solid within the volume of the food than would be possible by a purely superficial deposition of food additives, especially of salt.

Alternatively, the solid can be formed of the food additives by these being formed and frozen, optionally with addition of water. The freezing of the food additives can e.g. occur in a line adjacent to the press by cooling the line or by cooling the food additives in a static form.

For the first embodiment, the cooling for producing the solid by freezing can occur in a mixer or in a coating drum, every time with cooling. The process for introducing food additives provides for the food additives being a solid is accelerated, wherein the solid especially is solid salt, which can also be a solid mixture of salt with food additives, wherein the solid, respectively food additives, are especially free from solution water, especially free from liquid solution water. Generally preferred, the solid has a length bigger than its diameter. Preferably, the solid has a cylindric or rectangular, e.g. square cross-section, which extends constantly along an axis perpendicular thereto, which e.g. forms a longitudinal axis. In the alternative, the rod-shaped solid along an axis perpendicular to its cross-section can have a cross-section which sectionwise tapers and/or increases, e.g. with a second oval cross-section, perpendicular to the first one, so that the rod-shaped solid has e.g. the form of a drawn-out pellet.

The process results in the food additives being introduced as a solid directly into the food. The food is arranged on a carrier, so that it is arranged in an area adjacent to the carrier. The solid is preferably accelerated by means of a device, the outlet of which is oriented towards an area adjacent to the carrier, in which area the food is arranged.

In a first embodiment, the food additives, which preferably are present as a rod-shaped solid, are continuously or batchwise metered into a nozzle and accelerated by means of a compressed gas out of the nozzle's outlet, which is directed against the food. Generally, the rod-shaped solid can have a diameter of 0.2 or 0.5 mm up to 25 mm or up to 15 mm, e.g. to up to 10 mm, preferably 2 up to 7 mm or up to 6 mm, e.g. up to 3 mm or up to 2 mm, especially with a round cross-section, preferably at a length which is bigger than the diameter, e.g. by a factor 1.5 up to 20, e.g. by a factor 5 up to 10 longer than the diameter. Compressed gas can be applied to the nozzle continuously or controlled pulsatingly. Preferably, the food additives are batchwise metered into the nozzle, while compressed gas is applied controlled pulsatingly, especially controlled each time prior to, concurrent to or following the metering of the food additives into the nozzle.

The compressed gas can e.g. be air, nitrogen, helium, argon or mixtures of these under pressure or an ignitable gas mixture. The pressure can e.g. be 3 up to 700, e.g. up to 150 or up to 200 bar. Is preferred that the solid, when it is accelerated by compressed gas out of a pipe section, is accelerated to a speed of 200 up to 800 km/h, e.g. up to 250 up to 550 km/h or up to 350 km/h.

In embodiments, in which the food additives are present as a rod-shaped solid, the solid can be brought into the pipe section from a supply container and be accelerated by means of the pipe section by application of compressed gas. Therein, the pipe section at its inlet end can have a closure, which following introduction of rod-shaped solid is closed and subsequently gas is applied to a section of the pipe section between the closure and the rod-shaped solid. The pressure line, by which compressed gas is conducted to the pipe section, can discharge at the closure or into the pipe section. In this embodiment it is preferred that the food additives are formed into a rod-shaped solid by means of a press that is connected to a line. This can occur by pressing of solid food additives without addition of solution water or solvent or with addition of a small amount of solution water or solvent, respectively, wherein the press and/or the line connected thereto has a steam exit, from which the solution water and solvent, respectively exits as steam. Preferably, the press and/or the line is heated or frozen, especially deep frozen. Alternatively, for this embodiment, the food additives can be pressed into pellets and/or be frozen or be connected to agglomerates of food additives, e.g. by means of a coating drum.

The pipe section generally preferably for guiding the solid has an inner cross-section adapted to the cross-section of the solid. An inner cross-section adapted to the cross-section of the solid can receive the cross-section of the solid with a distance surrounding the solid of e.g. 0.1 up to 2 mm, preferably of up to 1.5 or up to 1 mm, e.g. with a fit that allows an acceleration of the solid through the pipe section. Optionally, the pipe section has at least one groove that runs longitudinal to the longitudinal axis of the pipe section in its inner wall as a spiral groove.

In the second embodiment, salt is formed by a press having an attached line into rod-shaped salt mass and is accelerated against the food directly or by means of a connected pipe section to which compressed gas is applied or in which a piston is guided.

In embodiments, in which the rod-shaped solid is accelerated in a pipe section against the food, it is preferred to arrange a lubricant between the rod-shaped solid and the pipe section. The lubricant can be arranged between the rod-shaped solid and the pipe section by coating the rod-shaped solid at least sectionwise, preferably completely circumferentially with the lubricant or by the pipe section having a feeding unit for the lubricant that introduces the lubricant into the pipe section and/or applies the lubricant to the rod-shaped solid. The lubricant can e.g. be water or a solid or liquid fat or oil, respectively, which in solidified form lies on the rod-shaped solid as a coating, or is introduced in liquid form into the pipe section.

A specific advantage of the process according to the invention is obtained when the food is freshly slaughtered meat, because rigor mortis (pig after ca. 45 min, cattle ca. 60-90 min) is reduced or even abolished by the fast introduction of salt into the volume of the freshly slaughtered meat. The product qualities are thereby significantly improved. Freshly slaughtered meat is preferably meat immediately following slaughtering, e.g. within at maximum 40, preferably at maximum 30, more preferably at maximum 20 or at maximum 10 minutes after the slaughtering for pork, and within at maximum 60, preferably at maximum 50, more preferably at maximum 40 or at maximum 30 min, even more preferred within at maximum 20 or 10 min after slaughtering for beef. In a further preferred process, the food is raw or cooked ham from pig or cattle. Therein, the solid can consist e.g. of at least 90 wt-% salt.

Correspondingly, the process relates to a process for the production of food, and especially meat, preferably freshly slaughtered meat, into which food additives in the form of a solid are introduced, especially food, which in the inside have food additives by introduction of the food additives in the form of a solid, especially in rod-shape. The food produced by the process provided with food additives in form of a solid in the inside, especially meat, is characterized in the embodiment, in which the solid is without solution water in that it does not contain any additional water, and no water introduced with the additives, respectively, and by puncture canals, through which the solid was introduced.

The invention is now described by way of examples and with reference to the figures, which schematically show in

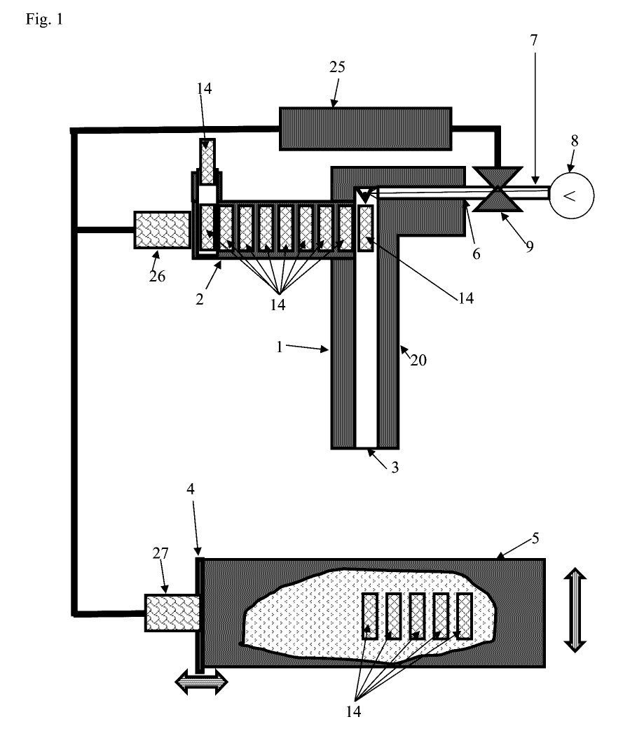

FIG. 1 a device according to the invention,

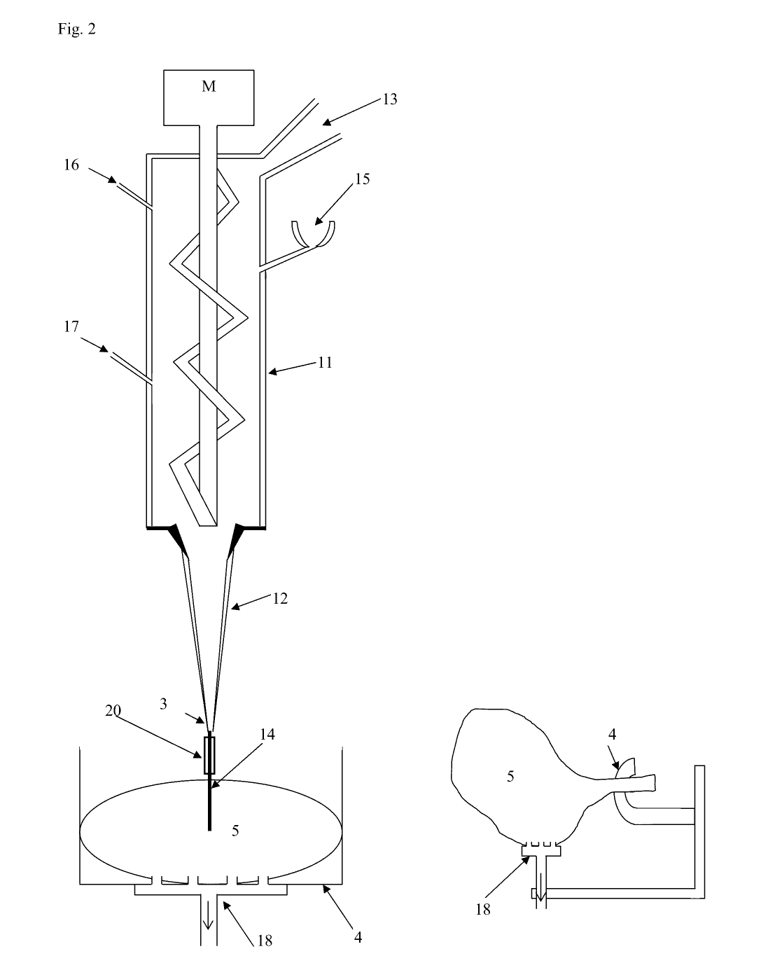

FIG. 2 a further device according to the invention,

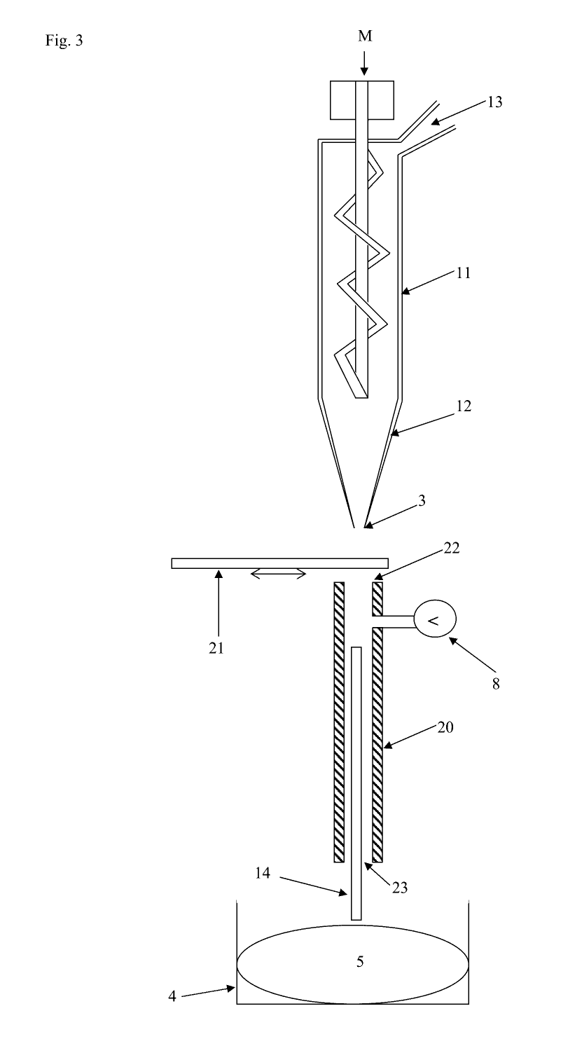

FIG. 3 a further device according to the invention,

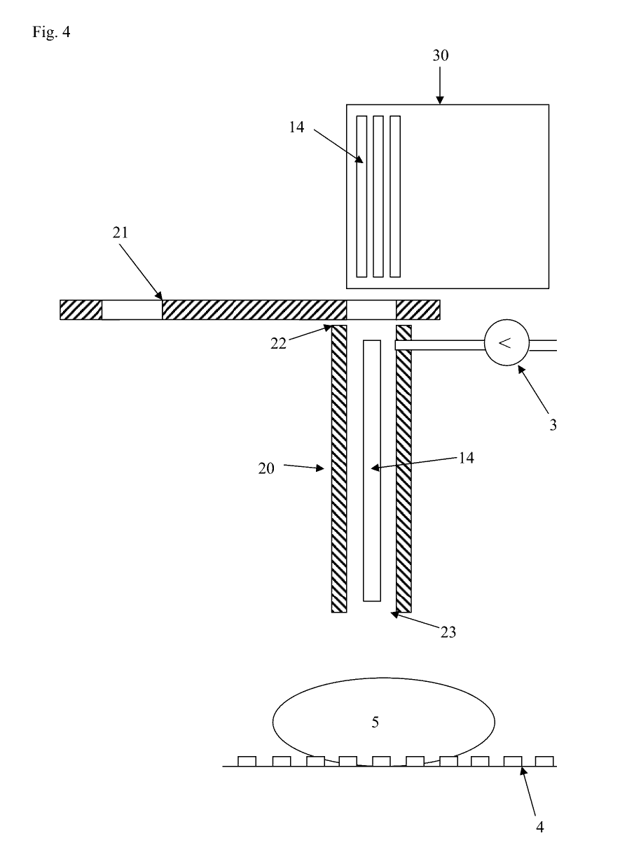

FIG. 4 a further device according to the invention,

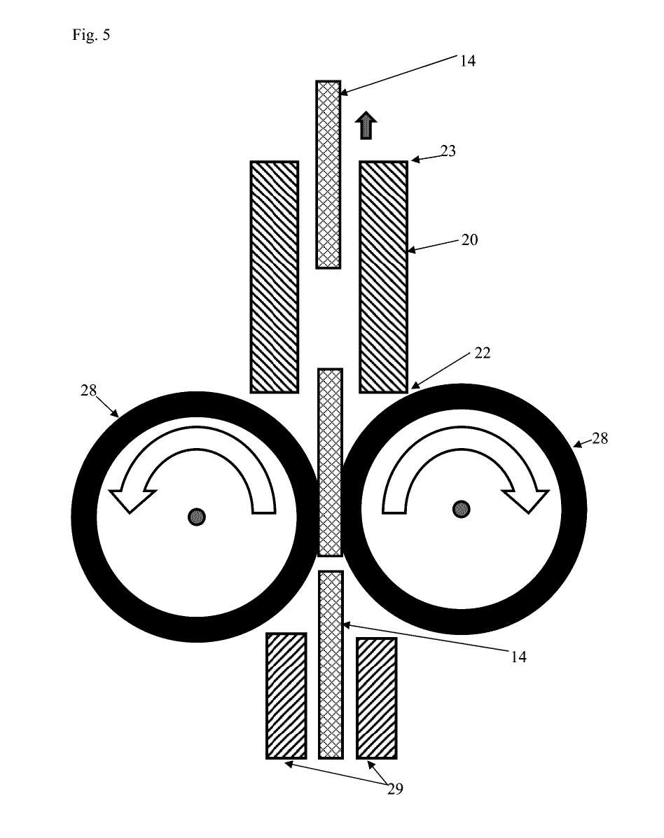

FIG. 5 a transportation device for the device according to the invention,

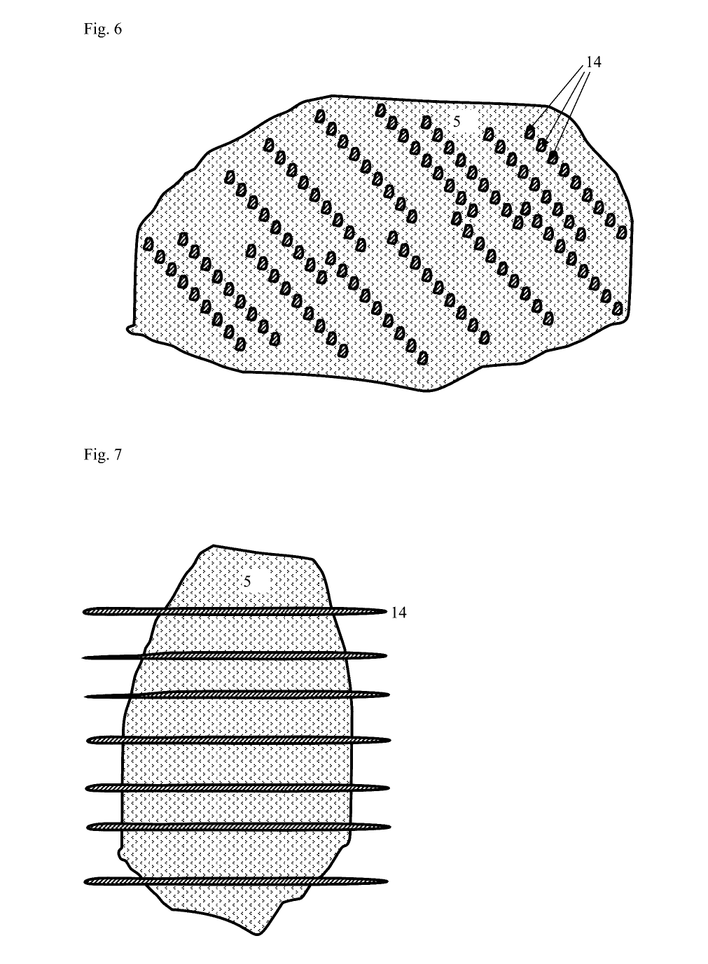

FIG. 6 a view of the food obtainable by the process, and in

FIG. 7 a view of the food obtainable by the process.

In the figures, functionally equal elements are provided with like reference numerals.

FIG. 1 shows a dosing unit 2, which introduces the rod-shaped solid 14 into a nozzle 1 shaped as a pipe section 20. The outlet end 23 of the pipe section 20 is directed onto the food 5 arranged at a carrier 4. The inlet 6 for compressed gas is connected by a pressure line 7 with a pressure source 8, which e.g. can be a pressure cylinder or a compressor, wherein in the pressure line 7 there is arranged a valve 9 controlling the admission of pressured gas into the pipe section 20. The dosing unit 2 is set up for feeding the food additives in the shape of the rod-shaped solid 14 into the pipe section 20 and can be embodied e.g. in the form of a moveable magazine, e.g. a drum magazine. The dosing unit 2 is filled with a rod-shaped solid 14, e.g. produced by means of a press from powdered additive. By opening the valve 9 compressed gas flows through pressure line 7 into the end of the pipe section 20 opposite its outlet end 23 and accelerates the rod-shaped solid 14 that was introduced by the dosing unit 2 into the pipe section 20 against the food 5. The rod-shaped solid 14 penetrates into the food 5 by the momentum it has received through the acceleration within the pipe section 20 as schematically visible for the section of the food 5 shown in cut-away. By moving the food 5, e.g. by a movement of the carrier 4 relative to the pipe section 20, several rod-shaped solids 14 can be introduced into the food 5.

The carrier 4 is moveable by means of the drive 27, as e.g. indicated by the two double-headed arrows along two directions of movement perpendicular to one another. Optionally, the drive 27 of the carrier 4 and/or the drive 26 of the metering unit 2 and/or the valve 9 for the compressed gas is controlled in dependence on a control unit 25.

FIG. 2 shows the embodiment in which a press 11 driven by a motor M, shown on the example of an extruder, conveys through a line 12 and forms into a rod-shaped solid 14, which is directly accelerated into the food 5 through the press 11. The press has an inlet for food additive, e.g. pourable salt, as well as according the preferred embodiment at least one feeding socket 17 and optionally an inlet having a heating device 15, each for food additives. By means of a suction device 18 arranged within a carrier 4 the food 5 is held without movement relative to the line 12, while the rod-shaped solid 14 is accelerated or pressed into the food out of the outlet 3. As an alternative to a carrier 4 encompassing the food 5 sectionwise, the carrier 4 can be hook to which the food 5 is attached, preferably in combination with a suction unit 18 which is directed against the area adjacent to the carrier 4 in which also the food 5 is arranged. An optional pipe section 20 serves for guiding the rod-shaped solid 14 exiting from the line 12.

FIG. 3 shows a transportation device having a pipe section 20 arranged between the outlet 3 of the line 12 and the carrier 4. The pipe section 20 has a closure 21 at its inlet end 22 and a pressure gas source 24 which is connected in the region of its inlet end 22. The pressure gas source 24 can be controlled by means of a valve and introduce for example CO₂, nitrogen or air corresponding to the pressure gas source 8 which is described with reference to FIG. 1 and the first embodiment. Preferably, the pipe section 20 is arranged on a common axis with the press 11 and the line 12 in order to transport rod-shaped solid 14 exiting from the outlet 3 into the pipe section 20 without damage when the closure 21 is open. In this, the closure 21 can separate off a section of the rod-shaped solid 14 which is transported along the outlet 3 in the pipe section 20. The rod-shaped solid 14 is accelerated out of the outlet end 23 of the pipe section 20 against the food 5 on the carrier 4 by means of the pressure gas source 24 which is connected to the pipe section 20 by the pressure line 7, which presently has no valve.

FIG. 4 shows a supply container 30, the outlet of which is preferably aligned in true alignment with the axis of a transportation device, which can be a pipe section 20 having a closure 21 arranged at an inlet end 22 as described with reference to FIG. 3, wherein in the region of the inlet end 22 a controlled pressure source 8 is connected. In this schematic representation, the rod-shaped solid 14 in the supply container is depicted smaller than in the pipe section 20. The supply container 30 can be arranged between a press 11 having a line 12 connected thereto and a transportation device. In this embodiment a rod-shaped solid 14 can be produced from the food additives by means of press 11 and line 12, be intermediately stored in supply container 30 and be introduced into the food 5 by means of the transportation device which comprises the pipe section 20 that is connected to a pressure source 8.

FIG. 5 shows an alternative conveyor device for rod-shaped solid 14 which has a pipe section 20 at the inlet end 22 of which there are arranged at least two contradirectionally driven traction wheels 28. The traction wheels are spaced from the longitudinal central axis of the pipe section (20) so that they are spaced about equally from the longitudinal central axis of the pipe section (20) in order to guide between themselves, to accelerate and to transport into the pipe section (20) the rod-shaped solid (14). For feeding the rod-shaped solid 14 between the circumferential faces of the traction wheels a pipe 29 can be arranged coaxially to pipe section 20 and in a distance to the traction wheels. Optionally, the circumferential faces of the traction wheels 28 are elastic, e.g. provided with a rubber layer. The circumferential faces of the traction wheels 28 can be arranged in a distance which approximately corresponds to the diameter of the rod-shaped solid 14 so that the traction wheels by their respective circumferential faces accelerate the rod-shaped solid 14 through the pipe section 20. The traction wheels 28 are driven to a circumferential speed which approximately corresponds to the desired speed of the rod-shaped solid 14, e.g. to a circumferential speed of about 100 to 200 km/h, e.g. 150 km/h.

FIG. 6 schematically shows a food that is produced according to the process of the invention using the device. The food 5 has entrance openings, in which the solid 14 is contained.

FIG. 7 schematically shows a cross-section through a food 5 into which the solid 14 of the food additives has been introduced by the process according to the invention. The depicted schematical cross-section through the food 5 shows that a rod-shaped solid 14 is introduced into the volume of the food 5 by the process according to the invention in the second embodiment.

### EXAMPLE 1

### Introduction of Salt by Means of Compressed Gas

Table salt representing a food additive was pressed into rod-shape having a round cross-section, ca. 2.8 mm diameter, ca. 5 to 20 mm long, by means of a press and introduced into the end of a pipe section (round inside, 6 mm inner diameter, 120 cm long). The end of the pipe section was closed and pressured gas was applied by means of a nitrogen cylinder (pressure 200 bar) which was fed through a line having a simple switching valve into the same end. The opposite opening of the pipe was directed onto ballistic gelatine having a Bloom number of 300 at a distance of 20 cm. The rod-shaped salt penetrated the gelatine, depending on the length, by ca. 5 to 15 cm.

### EXAMPLE 2

### Introduction of Food Additives by Means of a Press

Table salt superficially wetted with water in admixture with 1 wt-% seasoning, optionally glucose, as the food additive was pressed by means of an extruder into rod-shape from a line connected to the extruder as schematically shown in FIG. 2. The rod-shaped additive was pressed into the ballistic gelatine (Bloom number 300) immediately following exiting from the line, the gelatine being arranged at a distance from 1 to 10 cm from the line. The rod-shaped additive was cylindric and depending on the terminal cross-section of the line connected to the extruder had a diameter of 5 to 15 mm.

List of reference numerals

| | |
|---|---|
| 1 | nozzle |
| 2 | dosing unit |
| 3 | outlet |
| 4 | carrier |
| 5 | food |
| 6 | inlet |
| 7 | pressure line |
| 8 | pressure source |
| 9 | valve |
| 10 | drive |
| 11 | press |
| 12 | line |
| 13 | inlet |
| 14 | rod-shaped solid |
| 15 | heating |
| 16 | feeding tube |
| 18 | suction device |
| 20 | pipe section |
| 21 | closure |
| 22 | inlet opening |
| 23 | outlet opening |
| 25 | control unit |
| 26 | drive of dosing unit |
| 27 | drive of carrier |
| 28 | traction wheel |
| 29 | pipe |
| 30 | container |

1. Process for the production of food with the step of introducing at least one food additive into a food (5) by means of a conveyor device and a carrier (4) movable relative to the conveyor device, in the adjacent area of which the food (5) is arranged, characterized in that the food additive is present in the form of a rod-shaped solid (14) and the rod-shaped solid (14) is accelerated continuously or pulsatingly against the food (5).

2. Process according to claim 1, characterized in that the rod-shaped solid is formed out of food additive by means of a press (11) to which a line (12) is connected and after exiting from the line (12) and driven by the pressure of the press (11) is pushed into the food.

3. Process according to claim 1, characterized in that the rod-shaped solid (14) is introduced into a pipe section (20), the inner cross-section of which fittingly encompasses the solid (14) and the rod-shaped solid (14) is accelerated through the pipe section (20) and against the food (5) by means of a compressed gas, a propellant charge or a piston out of the pipe section (20) or by means of counter-directionally driven, spaced-apart traction wheels (28).

4. Process according to claim 1, characterized in that the solid (14) is produced by agglomerating and/or pressing and/or freezing the food additive.

5. Process according to claim 1, characterized in that the food additive is pressed into rod-shaped solid (14) by adding a mass of solution water and/or solvent to the food additive and feeding into a press (11) having a line (12) connected thereto, at least one of which having a steam exit, through which solution water and/or solvent is carried away in the form of steam.

6. Process according to claim 1, characterized in that the food additive contains at least 90 wt-% salt and is pressed into a rod-shaped solid (14) by feeding the food additives without solution water to a press (11), having a line (12) connected thereto for exiting of the rod-shaped solid (14).

7. Process according to claim 3, characterized in that a lubricant is arranged between the rod-shaped solid and the pipe section (20).

8. Process according to claim 1, characterized in that the food (5) is freshly slaughted meat and/or a piece of ham.

9. Use of a device for introducing food additives into solid foods (5) in a process according to claim 1, having a carrier (4) for arranging foods (5) in a region adjacent to the carrier (4), characterized by a press (11) having a line (12) connected thereto, which is arranged for forming the food additives to a rod-shaped solid (14), wherein the press (11) has an outlet (3) for accelerating the rod-shaped solid (14) on the line (12), the outlet (3) being directed to the region adjacent to the carrier (4).

10. Use according to claim 9, characterized in that the press (11) and/or the line (12) has at least one steam exit, from which solution water can exit in the form of steam.

11. Use according to claim 9, characterized in that the press (11) has a heating device (15) connected to its inner volume.

12. Use according to claim 9, characterized in that the press (11) for at least a portion of the food additives has a heating device (15), which can be heated to a temperature at which at least a portion of the food additives becomes flowable or melts and that the outlet (3) of the press (11) is connected to an inlet (6) of a pipe section (20).

13. Use according to claim 9, characterized in that adjacent to the press (11) there is arranged a pipe section (20) having an inlet opening at its inlet end (22) and an outlet opening (23) directed to the region adjacent to the carrier (4), the pipe section having a piston guided in the pipe section (20) or a pressure source (8) connected to the pipe section (20) in the region of its inlet and (22), or at least two driven traction wheels (28) spaced from the longitudinal central axis of the pipe section (20) and arranged in a distance to the pipe section (20).

14. Use according to claim 9, characterized in that the pipe section (20) has a feeding unit for a lubricant, which introduces the lubricant into the pipe section (20) and/or coats the lubricant onto the rod-shaped solid.

15. Use according to claim 9, characterized by a device for freezing the food additives into a rod-shaped solid (14) which is selected among a press (11) having an adjacent cooled line (12), a coating drum with cooling and a cooled static form.
